(19) United States
(12) Patent Application Publication
(10) Pub. No.: US 2021/0177193 A1
(43) Pub. Date: Jun. 17, 2021

(54) METHOD BY MEANS OF WHICH CAFFEINATED HOT BEVERAGES, PARTICULARLY COFFEE BEVERAGES, CAN BE PRODUCED BY AN APPARATUS FOR PRODUCING A CAFFEINATED HOT BEVERAGE

(71) Applicant: MELITTA PROFESSIONAL COFFEE SOLUTIONS GMBH & CO. KG, Minden (DE)

(72) Inventors: Thomas DIESTER, Bückeburg (DE); Bernd BUCHHOLZ, Rahden (DE); Patrick WILKE, Bückeburg (DE)

(73) Assignee: MELITTA PROFESSIONAL COFFEE SOLUTIONS GMBH & CO. KG, Minden (DE)

(21) Appl. No.: 16/973,897

(22) PCT Filed: Jul. 1, 2019
(86) PCT No.: PCT/EP2019/067536

§ 371 Date: Dec. 10, 2020

(30) Foreign Application Priority Data
Jul. 5, 2018 (DE) 10 2018 116 306.1

(51) Int. Cl. A47J 31/52; A47J 31/40

(52) U.S. Cl. CPC A47J 31/5253; B67D 1/0043; A47J 31/402

(57) ABSTRACT

A method for producing a hot beverage by an apparatus from water and a raw material in a brewing unit includes determining, by a measuring unit, an actual value of a physical material property and/or a physical variable dependent on the physical material property, and optionally a process property of the hot beverage, and comparing, with a control and/or regulating unit, the actual value and a set point value of the physical material property and/or the physical variable and optionally the process property. The control and/or regulating unit uses a data memory in which data records of set point values and/or set point value ranges are stored according to a temperature and/or a desired hot beverage type. If the actual value is outside the set point value range, a control and/or manipulated variable is adjusted by the control and/or regulating unit such that the physical material property of the hot beverage is influenced in a controlled or regulated manner.

### CROSS-REFERENCE TO RELATED APPLICATIONS

This application is a United States National Stage Application of International Application No. PCT/EP2019/067536 filed Jul. 1, 2019, claiming priority from German Patent Application No. 10 2018 116 306.1 filed Jul. 3, 2018.

### FIELD OF THE INVENTION

The present invention relates to a method for producing or manufacturing a hot beverage such as a caffeinated coffee beverage, wherein the production takes place, for example, in a fully automatic coffee machine. Although the following description often refers to caffeinated hot beverages, it will be obvious to those skilled in the art that the invention is equally applicable to non-caffeinated hot beverages.

### BACKGROUND

The extraction of a coffee beverage describes the extraction of aroma and flavor substances from ground coffee, especially from the so-called coffee grounds. This takes place during a brewing process, with water, preferably hot water, serving as the extraction agent. The extraction strength describes the amount of dissolved aroma and flavor compounds and is responsible for the taste characteristics of the coffee. If the extraction strength is high, a proportionate amount of tannins and bitter substances are dissolved from the ground coffee, resulting in an intense and tending to bitter coffee taste. A low extraction strength, on the other hand, releases proportionally more acidic components and produces a “thin” and rather watery coffee. The type and quantity of dissolved substances is not constant throughout the extraction process or extraction time, and optimum extraction strength may depend on the desired product properties.

German patent document DE 10 2015 109 921 A1 discloses a method for producing a coffee beverage from ground coffee by means of a brewing process in a coffee machine with a control device and with a brewing cylinder in which a piston is movably arranged, which has a piston drive so that the volume of a brewing chamber is variable, wherein the brewing process has at least the following method steps: S1: a quantity of ground coffee is filled into the brewing chamber; S2: water is passed through the ground coffee introduced into the brewing chamber in order to prepare the coffee beverage, wherein a volume flow, in particular the volume flow of the water flowing through the brewing chamber, is determined as a control variable and is compared with a volume flow setpoint value; and S3: in the event of deviations from a predetermined volume flow setpoint value determined in step S2, the position of the piston and thus the contact pressure force on the ground coffee in the brewing chamber is changed in a regulating manner as a manipulated variable in order to adjust the volume flow to the volume flow setpoint value. A process characteristic is thus determined in order to optimize the brewing process by controlling or regulating on the basis of this information.

### SUMMARY

The above generic method has proven to be very successful in itself, but the present invention has for its object to create further options for controlling or regulating the brewing process in order to produce a particularly good tasting coffee.

The present invention solves the above and other objects by an embodiment of a method for producing a hot beverage using a beverage dispenser for producing the hot beverage, the beverage dispenser including: a) a water pump connected to a water inlet for pumping water with a first temperature T1 from the inlet at a first flow rate; b) a boiler coupled to an output of the pump to heat the water to a second temperature T2, which is higher than the first temperature T1; (c) a brewing unit coupled to an output of the boiler for extracting the hot beverage from the raw material with the hot water; d) at least one measuring unit coupled to an output of the brewing unit for determining at least one of a physical material property of the hot beverage and a physical variable dependent on the physical property, and selectively a process property; and e) a control and/or regulating unit equipped for setting a control variable on the basis of the at least one of the physical material property and the physical variable, and the process property if selected, wherein the control and/or regulating unit comprises a data memory on which data records of at least one of setpoint values and setpoint value ranges are stored according to at least one of a temperature of the hot beverage and a supplied type of the raw material, the method comprising. A) determining, by the at least one measuring unit, an actual value of the at least one of the physical material property and the physical variable, and the process property, if selected, B) carrying out a comparison by the control and/or regulating unit between the actual value and a setpoint value range of the at least one of the physical material property and the physical variable, and the process property, if selected, wherein the control and/or regulating unit uses the data memory on which data records of the at least one of setpoints and setpoint value ranges are stored according to the at least one of the temperature and the type of raw material supplied to the brewing unit for extracting the desired hot beverage; and C) if the actual value is outside the setpoint value range, adjusting at least one of a regulating and manipulated variable by the control and/or regulating unit such that the physical material property of the dispensed hot beverage is influenced in a controlled or regulated manner.

The method according to the invention can be used to produce hot beverages, especially hot caffeinated coffee beverages. For this purpose, a device for producing a caffeinated hot beverage is used. The method can be used to prepare the caffeinated hot beverage. In particular, the hot beverage, in particular the caffeinated hot coffee beverage, is prepared from water, in particular heated water, and a starting material, in particular caffeinated ground coffee, at least in one brewing unit. The actual preparation is carried out by extraction, i.e. by extracting the aroma and flavor substances from the raw material, for example caffeinated ground coffee or so-called coffee grounds. This takes place during the brewing process, wherein water, preferably hot water, serves as the extraction agent. The method can include further optional method steps, such as a further introduction of water (at a specified temperature) downstream of the brewing unit, e.g. to produce an “Americano coffee” from an “espresso.” In addition, optional additives such as milk or milk foam can be added to the beverage exiting the brewing unit if desired.

The apparatus has at least

a) a water inlet of water, e.g. in the form of a water connection or a supply line of a water tank, having a first temperature T1 with a water pump at a first flow rate, (This first temperature can preferably be 4° C. to 30° C.)

b) a boiler for heating the water to a second temperature T2, which is higher than the first temperature T1, with which the heating is performed, (This second temperature can be in the preferred range of 80° C. to 96° C.)

c) a brewing unit for extracting the coffee beverage from ground coffee. (The extraction strength typically varies over the course of the extraction. In the brewing unit, the caffeinated beverage is prepared from water and the starting material,

d) at least one first measuring unit for determining at least one physical material property of the coffee beverage and/or a physical variable dependent thereon and optionally a process property, and

e) a control and/or regulating unit which is equipped for setting a control variable on the basis of the physical material property and/or the physical variable and optionally the process property, wherein the control and/or regulating unit has a data memory on which data records of setpoint values and/or setpoint value ranges are stored depending on the temperature and/or a desired caffeinated beverage and/or a supplied coffee type.

Since many of the material properties, e.g. viscosity or conductivity, are temperature-dependent and a typical brewing process takes place beyond standard conditions such as 25° C., it is recommended to store several setpoint values of the material property with the respective temperature.

The method has at least the following steps:

A) Determination of the physical material property and/or the physical variable and optionally the process property of the caffeinated hot beverage by at least the first measuring unit;

B) Carrying out a comparison with the control and/or regulating unit between an actual value and a setpoint value range of this physical material property, physical variable and optionally process property, wherein the control and/or regulating unit uses the data memory on which data records of setpoint values and/or setpoint value ranges are stored depending on the temperature and/or a desired caffeinated hot beverage and/or a supplied coffee type;

C) wherein, if the actual value is outside the setpoint value range, the control and/or regulating unit is used to set at least one manipulated variable in the process in such a way that the physical material property and/or the physical variable and optionally the process property of the dispensed caffeinated hot beverage is influenced in a controlled or regulated manner.

It is particularly advantageous that instead of or in addition to process properties (as in DE 10 2015 109 921 A1), now also or only one material property and/or a physical variable dependent thereon is taken into account, which allows the preparation process to be designed in an even better controlled or regulated manner in order to repeatedly obtain an excellently prepared and very good tasting coffee.

In particular, the extraction strength can be easily varied, especially product-specific and/or user-specific, by control or regulation.

During a dispensing, the control and/or regulating unit can determine a non-constant profile of setpoint values and/or setpoint value ranges that can be changed during a dispensing according to one embodiment, and then carry out the control. This increases the accuracy of the production process, as the extraction strength decreases over the course of the brewing process.

At least one of the physical material properties can be the electrical conductivity of the caffeinated hot beverage, according to a particularly advantageous variant.

The process property can be advantageous in terms of the brewing time of the caffeinated hot beverage.

To generate the manipulated variable, the actual value of the electrical conductivity and the actual value of a determined temperature of the caffeinated hot beverage can be compared to a respective setpoint value.

The at least one physical variable dependent on a physical material property can preferably be the refractive index of the caffeinated hot beverage.

A further supply of water, in particular hot water from the boiler, can take place after the brewing unit, wherein the manipulated variable is the volume of water or the time by means of which an essentially constant volume flow of water is supplied.

The water volume also changes the concentration and thus also the refractive index, conductivity or other material properties.

The setting in step C can be made in such a way that an initial volume of caffeinated hot beverage is diverted and thus not introduced into the beverage. Since the first portion of the caffeinated hot beverage prepared at the time contains a higher proportion of bitter substances, its discharge or failure to introduce this portion into the beverage influences a change in composition and thus in the physical properties of the substance.

During extraction, pressing forces can be applied to the ground coffee, wherein the manipulated variable is e.g. the motor power for applying the pressing forces.

A further addition of water to the beverage flowing out of the brewing unit can be advantageously carried out by an electrically adjustable actuator, in particular by a throttle valve.

During extraction, a contact pressure can be applied to the water as it passes through the ground coffee, wherein the power of the water pump can preferably be used as the manipulated variable.

Extraction can be performed by control and/or regulation to a setpoint value range of at least one or more physical material properties, physical variables and, optionally, one or more process properties.

Extraction can be performed by continuous regulation to a setpoint value range of at least one or more physical material properties, physical variables and, optionally, one or more process properties.

The control and/or regulation can be carried out by determining an extraction profile and by comparison with at least one extraction profile, which is stored as a setpoint value data set on the data memory.

The above-mentioned manipulated variables can be transmitted by a regulating and/or control signal. As an alternative to manipulated variables, they can also be control variables.

Furthermore, an automatic beverage dispenser which has a measuring unit with one of several sensors as well as a control and/or evaluation unit which is equipped to carry out the above mentioned method according to the invention is also in accordance with the invention.

### DESCRIPTION OF THE DRAWINGS

In the following, the invention is explained in more detail in several embodiments on the basis of the accompanying figures, wherein the invention is not limited to the concretely represented embodiments, wherein:

FIG. 1: shows a schematic representation of different embodiments for carrying out a method for producing a hot beverage according to the invention;

FIG. 2: shows a schematic representation of a first embodiment shown in FIG. 1;

FIG. 3: shows a schematic representation of a second embodiment shown in FIG. 1;

FIG. 4: shows a schematic representation of a third embodiment shown in FIG. 1; and

FIG. 5: a schematic representation of a fourth embodiment shown in FIG. 1.

### DETAILED DESCRIPTION

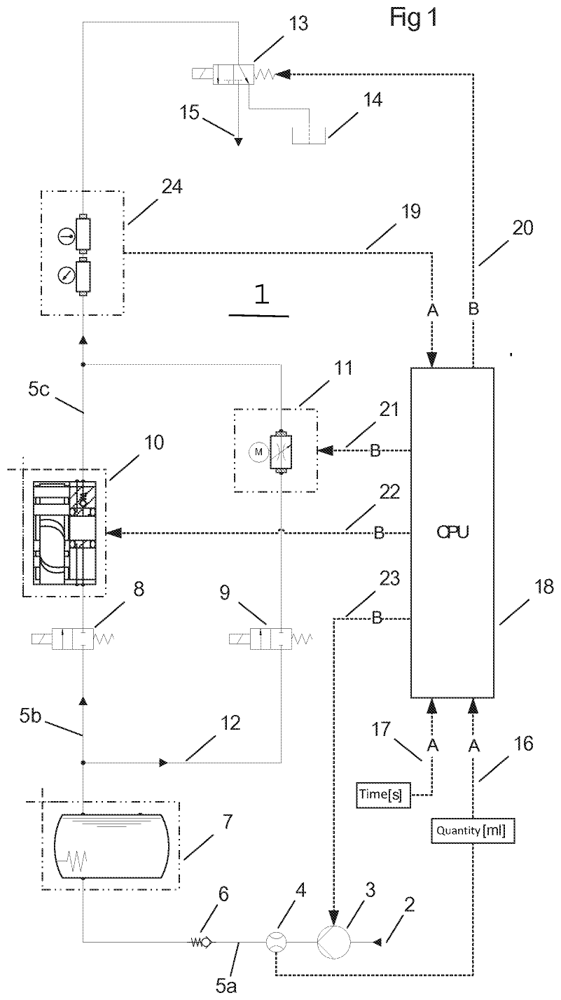

FIG. 1 shows a method for a coffee preparation process depending on the known and/or measured extraction or extraction-influencing variables or is adapted and influenced by extraction-influencing variables. The influence can be based on a measurable physical variable, e.g. time or water quantity, on the basis of stored specifications and/or the measurement and evaluation of a measurable physical material property, e.g. electrical conductivity or refractive index, which allows a conclusion to be drawn about the extraction.

A substance property is a substance-specific quantity, such as conductivity or viscosity, which can vary from substance or mixture of substances. Often only dependent physical variables are measured, e.g. in the case of thermal conductivity of a flowing medium, the temperature of the medium and its change over time can be measured at two different points.

In contrast, a process property is a property that depends on the process and the process control. This is e.g. the medium temperature or the volume and/or mass flow of a medium, which is not substance specific but process dependent. Only these were considered according to the prior art mentioned above. According to the prior art, this is still optionally possible. Primarily, however, a material property or a physical variable dependent on it is used for control or regulation.

The influence of the determined substance properties and, if applicable, process properties on the preparation process of the caffeinated hot beverage can be passively influenced by disposing of coffee quantities that are not within the target range. The first or last quantities of coffee emerging from the brewing chamber cannot be dispensed and can be disposed of instead, for example to produce a coffee without crema. However, the influence can also be carried out actively, e.g. by changing the extraction or extract, especially during preparation.

According to one embodiment, disposal of the first part of an espresso preparation, for example, preferably depending on the measured extraction strength, can be advantageously provided. This is because this a first part of the preparation may contain more undesirable substances in the extract. These undesirable substances, since they have a negative influence on the taste, are for example bean fat, which was on the surface of the coffee bean to be ground and has oxidized there through contact with oxygen, and/or a proportion of grinding dust, which is produced with fine grinding degrees. Both substances result in a rancid and flat taste, which can be avoided if they are “rinsed out” in advance.

In addition, filter coffee beverages are becoming increasingly popular again on the market and the production of a comparable taste profile on a fully automatic coffee machine is therefore a clear purchasing criterion for the user. The required taste profile of a filter coffee differs significantly from a similar product type produced on a fully automatic coffee machine due to the different preparation methods, brewing systems and grind levels. A coffee beverage with similar characteristics (no crema, lower bitter substances, hardly any acidity, etc.) can best be reproduced on a fully automatic coffee machine with piston brewing system if hot water is added to the extracted coffee in a controlled manner using stored extraction profiles. In this case, therefore, the mixing can take place parallel to the brewing process, the water quantity/volume flow can be constant or preferably variable and can preferably also be monitored once or continuously. This procedure prevents the dissolution of undesirable high concentrations of bitter substances and acids, which would otherwise remain clearly perceptible even if the coffee were to be completely “diluted” afterwards. In this way, the relatively low weights with high extraction strength of a piston system can be used to reproduce the specific design patterns of filter coffee production.

With such a system/method it is possible to adjust customer wishes and requirements to the taste profile of the coffee individually for each product and to produce them reproducibly, as well as to compensate for fluctuations e.g. in the quantity of ground coffee.

FIG. 1 shows a first embodiment of a beverage dispenser 1 according to the present invention. The illustrated embodiment comprises several options for an extraction-dependent preparation of a caffeinated hot beverage. These options can obviously also be implemented separately in a multitude of other embodiment of the method, either analogously or in modified form.

The beverage dispenser 1 is here designed as a fully automatic coffee machine. It has a water connection 2, which can be connected for example to a conventional water tap, a house pipe or the like.

A supply line 5a extends from water connection 2. A pump 3 is arranged along the supply line, which pumps the water supplied to the beverage dispenser land/or applies pressure to it.

The supply line 5a leads up to a boiler 7 which heats the water, where the supply line changes into a hot water line 5b. The flow rate in the supply line 5a or the hot water line 5b can be measured by a flowmeter 4 for monitoring the respective volume and/or mass flow in the hot water line. The flowmeter can be an impeller flowmeter or a magnetic-inductive flowmeter.

A non-return valve 6, in particular a spring-loaded non-return valve 6, is arranged downstream of the flowmeter 4 along the supply line 5a. The supply line 5a then opens into the boiler 7, which heats the supplied water to a temperature in the preferred range of 80° C. to 96° C.

The water supplied to the boiler 7 through the supply line 5a can be cold water, e.g. with a temperature between 4° C. and 30° C.

A directional control valve 8, which in this case is preferably designed as a 2/2 directional control valve, in particular as an electrically operated 2/2 directional control valve with spring return, is arranged downstream of the boiler 7 for transferring a discrete quantity of water to a brewing unit 10.

The directional control valve 8 can interact with a control and/or evaluation unit 18 of the beverage dispenser or communicate wirelessly or by wire. It is thus possible that depending on the beverage selected by the user, less or more water is supplied in a defined manner to the brewing unit 10. For example, a different amount of water is required for differently large coffees.

Brewing unit 10 contains the ingredients for preparing the caffeinated hot beverage. This can preferably be ground coffee. Water is fed into the brewing unit. In brewing unit 10, the caffeinated hot beverage is thus made available by extraction at a temperature typically above 70° C.

From the brewing unit 10, the prepared hot beverage flows into a dispensing line 5C.

A bypass line 12 branches off from the hot water line 5b between the boiler 7 and the directional control valve 8. Along the bypass line 12, a directional control valve 9, preferably in the form of a 2/2 directional control valve, in particular an electrically operated 2/2 directional control valve with spring return, is arranged for transferring a discrete quantity of hot water to a quantity of caffeinated hot beverage, in particular coffee, prepared by the brewing unit 9. In this way, the prepared coffee can be diluted with the hot water. The bypass line 12 serves to bypass the brewing unit. It allows hot water from boiler 7 and hot water line 5b to be fed directly into the coffee flowing out of brewing unit 10, bypassing brewing unit 10. For this purpose, the hot water line 5b opens into the dispensing line 5c.

Along the bypass line 12, an actuating element 11 is arranged downstream of the directional control valve 9 in terms of flow, which serves to control and/or regulate the quantity of water supplied through the bypass line. The actuating element 11 can be designed as an electrically adjustable throttle valve.

A measuring unit 24 is preferably arranged downstream of the inlet or orifice region where the bypass line 12 leads back into the dispensing line 5c, downstream of the brewing unit 10 or to the caffeinated beverage. The measuring unit 24 can have one or more sensors.

Finally, the caffeinated hot beverage is transferred to a dispensing unit 15. This may include a diverter valve 13 in the form of a directional valve, preferably a 3/2 directional valve, in particular an electrically operated 3/2 directional valve with spring return. The dispensing unit 15 is used to dispense the beverage in the dispensing line 5c into a container, e.g. a cup or mug. Usually, the dispensing unit 15 can have one or more additional lines 14, e.g. for discharge into a discharge tray or into a drain. The diverter valve 13 thus directs the caffeinated hot beverage either in the direction of the dispenser or into line 14 for discharge into the drain or the drain pan.

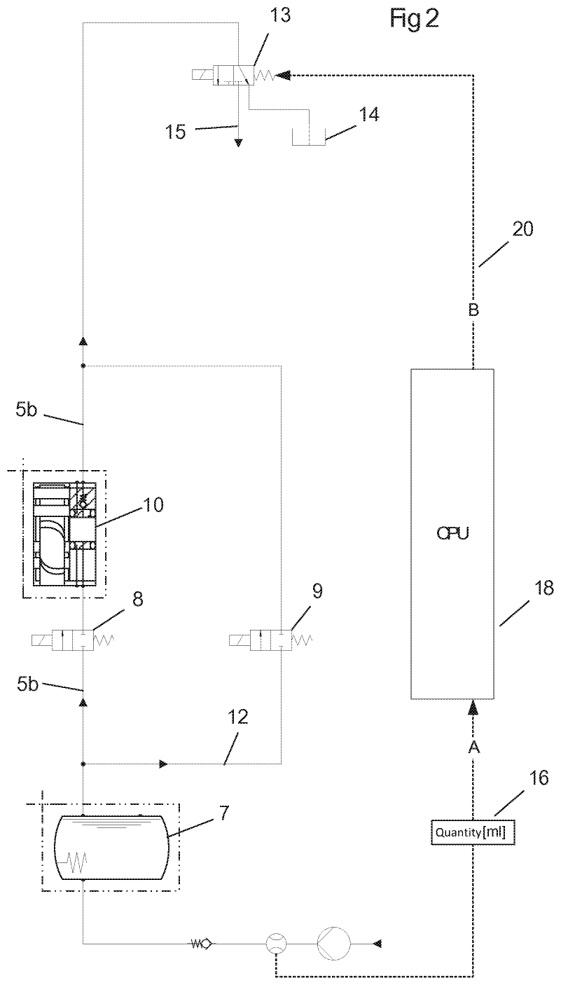

FIG. 2 shows a first preferred embodiment of the process control from FIG. 1, which can be implemented separately as a of FIG. 2 or as part of a more complex apparatus as shown in FIG. 1. The same applies to FIGS. 2 to 5.

By means of the flowmeter 4 of FIG. 1, the volume and/or mass flow in the supply line 5a can be transmitted as measuring signal 16 to the control and/or evaluation unit 18. With this embodiment, one or more control and/or regulation signals 20 can thus be generated by the control and/or evaluation unit 18 depending on the water quantity per time unit during the brewing process. These set or regulate a manipulated or control variable.

A corresponding control and/or regulation signal 20 can be issued to the diverter valve 13, for example. With this embodiment of influencing, defined quantities of coffee that are not within the target range of extraction can be disposed of in the drain and thus not be fed into the beverage, depending on the control variable used.

A predefined proportion (e.g. at the start of extraction) of a coffee quantity of the brewing process, individually assigned and set for a specific product, is thus measured by the flowmeter.

The set quantity of coffee, of the defined proportion, is fed into line 14 via the diverter valve 13 and thus not dispensed into the beverage. This can be carried out after a fixed time interval or until the flow rate is changed.

With this passive influence, e.g. bitter substances, which are increasingly dissolved at the beginning of the extraction, are unable to reach the beverage.

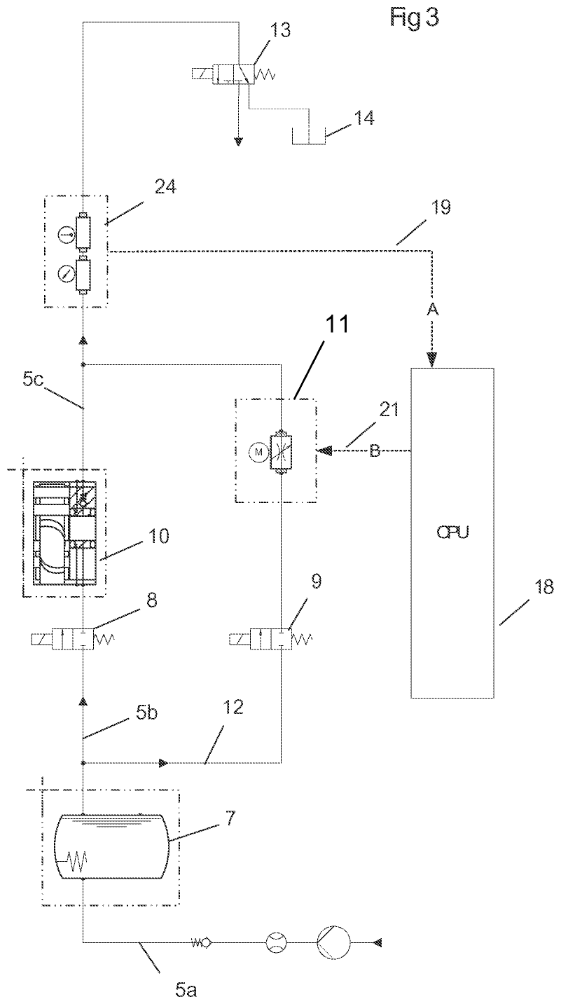

In FIG. 3 a physical material property is determined at the measuring unit 24. A physical material property can be selected in particular from the following variables: conductivity in mS/cm, TDS (total dissolved solids) in ppm, refractive index in degrees Brix, density in kg/m₃, viscosity in Pa*s. In addition, or as an alternative to the above-mentioned material variables, the temperature in ° C. of the freshly brewed caffeinated hot beverage can also be determined.

With this embodiment, actions and reactions can be carried out depending on a measured value which is recorded between the brewing unit and the output during the production process. A control and/or regulation signal 21 can then also be generated from this measuring signal 19 by the control and/or evaluation unit 18.

After the brewing process, the extraction strength of the coffee is determined by the measuring unit 24 and compared with a setpoint value range assigned and set individually for each product. This setpoint value range can be stored as a data record on a data memory of the control and/or evaluation unit 18.

Depending on the measured values, hot water can be added to the coffee via actuating element 11, e.g. in the form of an automatically adjustable throttle valve, and the extraction strength of the beverage can thus be actively influenced.

In FIG. 3 only the hot water supply is shown, but it is also conceivable that a branch may be arranged e.g. as a bypass line before boiler 7.

The measurement and influencing can be carried out continuously, wherein the continuous repetition of the process results in a regulation system which continuously monitors the adherence to the target ranges.

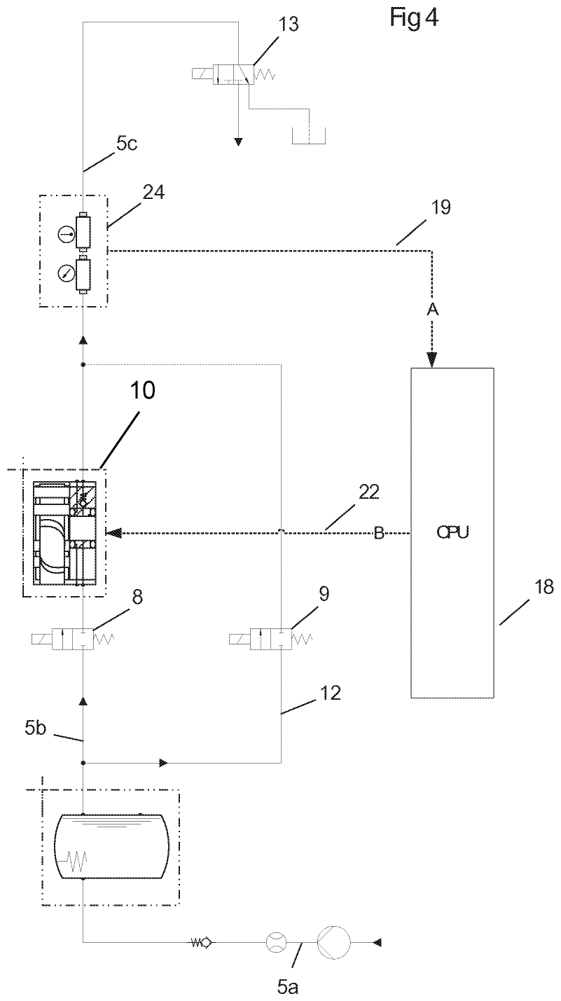

FIG. 4 shows a determination of a measuring signal 19 analogous to FIG. 3, wherein the control and/or regulating unit 18 in this case generates a regulation signal 22, with which the pressing forces for compressing the ground coffee or coffee grounds are influenced or the pressing forces are applied to a piston which presses the liquid through the ground coffee.

With this embodiment of influencing, the pressing forces in the brewing unit can be optionally automatically adjusted according to the dependency used and thus the contact/extraction time can be used to react to deviations from the target range of the extraction. After the brewing process, the extraction strength of the coffee is thus determined by the measuring unit 24 and compared, analogous to FIG. 2, with a setpoint value range that is assigned and set individually for each product.

Depending on the measuring signal 19, the ground coffee in the brewing unit 10 is pressed more or less strongly, wherein the contact time or extraction time is extended or shortened accordingly and the extraction strength increases or decreases accordingly.

The measurement and influencing can be carried out continuously, whereby the continuous repetition of the process results in a regulation which continuously monitors the adherence to the target ranges.

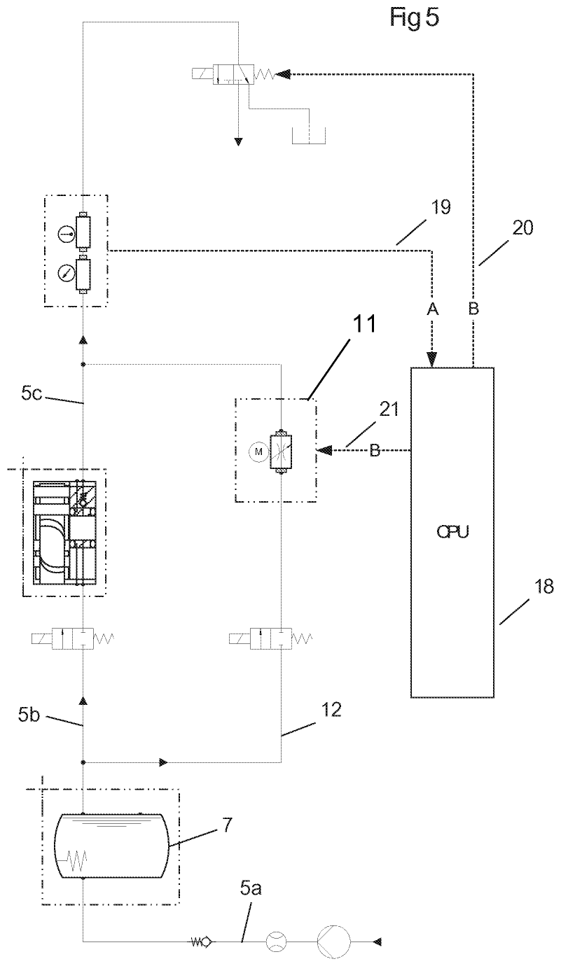

FIG. 5 shows a embodiment of the invention in which a passive influence analogous to FIG. 2 is effected by discharging part of the caffeinated hot beverage and an active influence by supplying hot water analogous to FIG. 3.

A predefined extraction range, e.g. a high range which is greater than a predefined extraction strength X at the start of the brewing process, is determined with or at the measuring unit 24 and directed to the drain via the diverter valve 13.

After the disposal of a partial volume of the caffeinated hot beverage, e.g. the portion with particularly high bitter substances, hot water is added to the extract, depending on the measuring signal 19, via the actuating element 11, which is preferably designed as an automatically adjustable throttle valve, and the extraction strength of the beverage is thus actively regulated into the target range.

The disposal of the over-extracted coffee and the subsequent continuous regulation process allows the beverage to be prepared in a defined extraction area throughout the entire brewing process.

A further control and/or regulating signal 23 shown in FIG. 1 can be used to set or regulate the brewing water volume flow. In this embodiment of influencing, the hot water volume flow supplied to the brewing unit can be optionally automatically adjusted according to the used dependency and thus react to deviations from the extraction target range.

The embodiments of dependencies [A] and influences [B] shown in FIG. 1 can be combined in an advantageous way, which extends the uses of such a system/method. In the exemplary embodiments described above, the basic conditions (water quantities, beverage size, grinding degree, extraction target ranges and coffee properties) can be known and/or are adjustable.

1. A method for producing a hot beverage using a beverage dispenser for producing the hot beverage, the beverage dispenser including: a) a water pump connected to a water inlet for pumping water with a first temperature T1 from the inlet at a first flow rate; b) a boiler coupled to an output of the pump to heat the water to a second temperature T2, which is higher than the first temperature T1; (c) a brewing unit coupled to an output of the boiler for extracting the hot beverage from the raw material with the hot water; d) at least one measuring unit coupled to an output of the brewing unit for determining at least one of a physical material property of the hot beverage and a physical variable dependent on the physical property, and selectively a process property; and e) a control and/or regulating unit equipped for setting a control variable on the basis of the at least one of the physical material property and the physical variable, and the process property, if selected, wherein the control and/or regulating unit comprises a data memory on which data records of at least one of setpoint values and setpoint value ranges are stored according to at least one of a temperature of the hot beverage and a supplied type of the raw material, the method comprising:
A) determining, by the at least one measuring unit, an actual value of the at least one of the physical material property and/or the physical variable, and the process property, if selected;
B) carrying out a comparison by the control and/or regulating unit between the actual value and a setpoint value range of the at least one of the physical material property and the physical variable, and the process property, if selected, wherein the control and/or regulating unit uses the data memory on which data records of the at least one of setpoints and setpoint value ranges are stored according to the at least one of the temperature and the type of raw material supplied to the brewing unit for extracting the desired hot beverage; and
C) if the actual value is outside the setpoint value range, adjusting at least one of a regulating and manipulated variable by the control and/or regulating unit such that the physical material property of the dispensed hot beverage is influenced in a controlled or regulated manner.

2. The method according to claim 1, including determining by the control and/or regulating unit at least one of a non-constant profile of setpoint values and setpoint value ranges which is variable during dispensing, and thereafter carrying out the control or regulation.

3. The method according to claim 1, wherein the physical material property is the electrical conductivity of the hot beverage.

4. The method according to claim 1, wherein the process property is the brewing time of the hot beverage.

5. The method according to claim 3, wherein the process property is the temperature of the hot beverage.

6. The method according to claim 5, including comparing at least one of the actual value of the electrical conductivity and the actual value of the temperature of the hot beverage with a respective setpoint value to produce the at least one of the control and manipulated value used in the adjusting step.

7. The method according to claim 1, wherein the physical variable dependent on the physical material property is the refractive index of the hot beverage.

8. The method according to claim 1, wherein the process property is the brewing time.

9. The method according to claim 1, further comprising supplying a volume of a supplementary supply of hot water from the boiler into the hot beverage downstream of the brewing unit, wherein the manipulated variable is one of the volume of the supplementary supply of water and the time during which a substantially constant volume flow of hot water is supplied.

10. The method according to claim 9, wherein the supplying of the volume of the supplementary supply of hot water is carried out in dependence of the at least one of the measured physical material property and the physical variable dependent on the measured physical material property.

11. The method according to claim 1, wherein the adjusting in step C) includes diverting an initial volume of the hot beverage output from the brewing unit which does not become part of the hot beverage dispensed by the dispenser.

12. The method according to claim 1, further including exerting pressing forces on the raw material during an extraction of the hot beverage in the brewing unit, wherein the manipulated variable is a motor power used to apply the pressing forces.

13. The method according to claim 9, wherein the supplying of the supplementary supply of hot water is effected using an electrically adjustable actuating element.

14. The method according to claim 1, further including exerting pressing forces on the raw material during an extraction of the hot beverage in the brewing unit wherein the manipulated variable is a power of the water pump.

15. The method according to claim 1, further including controlling an extraction of the hot beverage from the raw material in the brewing unit to a setpoint value range of at least one of the physical material property and the physical variable and the process property, if selected.

16. The method according to claim 1, the extraction is carried out by continuous regulation to a setpoint value range of at least one or more physical material property, physical variable and process property.

17. The method according to claim 1, including determining an extraction profile of the raw material, forming a comparison of the determined extraction profile with at least one extraction profile stored as a setpoint value data record in the data memory, wherein the adjusting step includes controlling and/or regulating the extraction profile as a function of the comparison.

18. A hot beverage dispenser for producing a hot beverage, comprising:
a water pump connected to a water inlet for pumping water with a first temperature T1 from the inlet at a first flow rate;
a boiler coupled to an output of the water pump to heat the water to a second temperature T2 which is higher that the first temperature T1;
a brewing unit coupled to an output of the boiler for extracting hot beverage from a raw material with the hot water to produce the hot beverage;
at least one measuring unit coupled to an output of the brewing unit for determining at least one of a physical material property of the hot beverage and a physical variable dependent on the physical property and selectively a process property; and
a control and/or regulating unit equipped for setting a control variable on the basis of at least one of the physical material property and the physical variable, and the process property if selected, wherein the control and/or regulating unit comprises a data memory on which data records of at least one of setpoint values and setpoint value ranges are stored according to at least one of a temperature of the hot beverage and a type of the raw material used in the brewing unit.
